(19) United States
(12) Patent Application Publication
(10) Pub. No.: US 2013/0157671 A1
(43) Pub. Date: Jun. 20, 2013

(54) METHOD AND APPARATUS FOR COMPUTING A SCHEDULED LOAD IN WIRELESS COMMUNICATIONS

(71) Applicants: Yan ZHOU, San Diego, CA (US); Farhad Meshkati, San Diego, CA (US); Dilip K. Madathil, San Diego, CA (US); Mohit Anand, San Diego, CA (US); Mehmet Yavuz, San Diego, CA (US)

(72) Inventors: Yan ZHOU, San Diego, CA (US); Farhad Meshkati, San Diego, CA (US); Dilip K. Madathil, San Diego, CA (US); Mohit Anand, San Diego, CA (US); Mehmet Yavuz, San Diego, CA (US)

(73) Assignee: QUALCOMM Incorporated, San Diego, CA (US)

(21) Appl. No.: 13/526,798

(22) Filed: Jun. 19, 2012

Related U.S. Application Data
(60) Provisional application No. 61/499,068, filed on Jun. 20, 2011.

(51) Int. Cl. H04W 52/02

(52) U.S. Cl. CPC H04W 52/0206
USPC 455/450

(57) ABSTRACT

Methods and apparatuses are provided for adjusting a scheduled load for one or more user equipment (UE) in a wireless network. A comparison of each of one or more control parameters related to signals received from one or more UEs to a corresponding threshold can be determined. The control parameters can correspond to an in-cell load, rise-over-thermal, etc. The scheduled load of a base station can be adjusted based in part on the comparison. This adjustment can include adjusting the scheduled load by a step-size increase value or step-size decrease value, which can be computed based in part on a target tail probability for the one or more control parameters.

### CLAIM OF PRIORITY UNDER 35 U.S.C. §119

The present Application for Patent claims priority to Provisional Application No. 61/499,068, entitled “METHOD AND APPARATUS FOR COMPUTING A SCHEDULED LOAD IN WIRELESS COMMUNICATIONS” filed Jun. 20, 2011, assigned to the assignee hereof and hereby expressly incorporated by reference herein.

### BACKGROUND

1. Field

The following description relates generally to wireless network communications, and more particularly to determining scheduled load for low power base stations.

2. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP) (e.g., 3GPP LTE (Long Term Evolution)/LTE-Advanced), ultra mobile broadband (UMB), evolution data optimized (EV-DO), etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth.

To supplement conventional base stations, additional restricted access base stations can be deployed to provide more robust wireless coverage to mobile devices. For example, wireless relay stations and low power base stations (e.g., which can be commonly referred to as Home NodeBs or Home eNBs, collectively referred to as H(e)NBs, femto nodes, pico nodes, etc.) can be deployed for incremental capacity growth, richer user experience, in-building or other specific geographic coverage, and/or the like. Such low power base stations can be connected to the Internet via broadband connection (e.g., digital subscriber line (DSL) router, cable or other modem, etc.), which can provide the backhaul link to the mobile operator's network. Thus, for example, the low power base stations can be deployed in user homes to provide mobile network access to one or more devices via the broadband connection. Because deployment of such base stations is unplanned, low power base stations can interfere with one another where multiple stations are deployed within a close vicinity of one another. To mitigate such interference, a transmit power or data rate of served UEs can be controlled (e.g., through resource allocation or otherwise) to maintain a specified rise-over-thermal (RoT) at the low power base station.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, the present disclosure describes various aspects in connection with computing a scheduled load for a low power base station, such as a femto node, to achieve a target tail probability for one or more signal measurements. For example, the target tail probability can correspond to a rise-over-thermal (RoT), in-cell load, joint RoT and in-cell load, and/or the like. In one example, a step size for achieving the target tail probability can be determined based in part on one or more control parameters of signals received from one or more served user equipment (UE), such as RoT, in-cell load, and/or the like. In this regard, where signal measurements for achieving the target tail probability are below a threshold, a scheduled load at the femto node can be increased by the computed step size in an attempt to maximize throughput while achieving the target tail probability. Similarly, where the signal measurements are over a threshold, the scheduled load can be decreased by the same, or a separately computed, step size.

According to an aspect, a method for adjusting a scheduled load for one or more UEs in a wireless network is provided. The method includes computing a step-size increase value and a step-size decrease value for adjusting a scheduled load based in part on a target tail probability for one or more control parameters, and determining a comparison of each of the one or more control parameters related to signals received from one or more UEs to a corresponding threshold. The method further includes adjusting the scheduled load by the step-size increase value or the step-size decrease value based in part on the comparison.

In another aspect, an apparatus for adjusting a scheduled load for one or more UEs in a wireless network is provided. The apparatus includes at least one processor configured to compute a step-size increase value and a step-size decrease value for adjusting a scheduled load based in part on a target tail probability for one or more control parameters and determine a comparison of each of the one or more control parameters related to signals received from one or more UEs to a corresponding threshold. The at least one processor is further configured to adjust the scheduled load by the step-size increase value or the step-size decrease value based in part on the comparison. The apparatus further includes a memory coupled to the at least one processor.

In yet another aspect, an apparatus for adjusting a scheduled load for one or more UEs in a wireless network is provided. The apparatus includes means for computing a step-size increase value and a step-size decrease value for adjusting a scheduled load based in part on a target tail probability for one or more control parameters. The apparatus further includes means for determining a comparison of each of the one or more control parameters related to signals received from one or more UEs to a corresponding threshold and means for adjusting the scheduled load by the step-size increase value or the step-size decrease value based in part on the comparison.

Still, in another aspect, a computer-program product for adjusting a scheduled load for one or more UEs in a wireless network is provided including a non-transitory computer-readable medium having code for causing at least one computer to compute a step-size increase value and a step-size decrease value for adjusting a scheduled load based in part on a target tail probability for one or more control parameters and code for causing the at least one computer to determine a comparison of each of the one or more control parameters related to signals received from one or more UEs to a corresponding threshold. The computer-readable medium further includes code for causing the at least one computer to adjust the scheduled load by the step-size increase value or the step-size decrease value based in part on the comparison.

Moreover, in an aspect, an apparatus for adjusting a scheduled load for one or more UEs in a wireless network is provided that includes a step-size initializing component for computing a step-size increase value and a step-size decrease value for adjusting a scheduled load based in part on a target tail probability for one or more control parameters. The apparatus further includes a control parameter measuring component for determining a comparison of each of the one or more control parameters related to signals received from one or more UEs to a corresponding threshold and a scheduler component for adjusting the scheduled load by the step-size increase value or the step-size decrease value based in part on the comparison.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 is a block diagram of an example wireless communication system for employing a plurality of femto nodes.

FIG. 2 is a block diagram of an example wireless communication system for adjusting scheduled load of a base station based on one or more control parameters.

FIG. 3 is a flow chart of an aspect of an example methodology for adjusting a scheduled load based on one or more control parameters.

FIG. 4 is a flow chart of an aspect of an example methodology for adjusting a scheduled load based on an in-cell load.

FIG. 5 is a block diagram of a system in accordance with aspects described herein.

FIG. 6 is a block diagram of an aspect of a system that adjusts a scheduled load based on one or more control parameters.

FIG. 7 is a block diagram of an aspect of a system that adjusts a scheduled load based on an in-cell load.

FIG. 8 is a block diagram of an aspect of a wireless communication system in accordance with various aspects set forth herein.

FIG. 9 is a schematic block diagram of an aspect of a wireless network environment that can be employed in conjunction with the various systems and methods described herein.

FIG. 10 illustrates an example wireless communication system, configured to support a number of devices, in which the aspects herein can be implemented.

FIG. 11 is an illustration of an exemplary communication system to enable deployment of femtocells within a network environment.

FIG. 12 illustrates an example of a coverage map having several defined tracking areas.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As described further herein, an uplink scheduled load of a low power base station, such as a femto node, can be adjusted in an attempt to achieve a target tail probability for one or more signal measurements, such as rise-over-thermal (RoT), in-cell load, joint RoT and in-cell load, and/or the like. In one example, in-cell load target tail probability is used where the RoT at the femto node is maximized to increase tolerance to out-of-cell interference from one or more interfering nodes or UEs. Also, for example, the scheduled load can be increased or decreased by one or more step sizes, which can be computed based in part on one or more control parameters, such as RoT, in-cell load, and/or the like, to achieve the target tail probability.

A low power base station, as referenced herein, can include a femto node, a pico node, micro node, home Node B or home evolved Node B (H(e)NB), relay, and/or other low power base stations, and can be referred to herein using one of these terms, though use of these terms is intended to generally encompass low power base stations. For example, a low power base station transmits at a relatively low power as compared to a macro base station associated with a wireless wide area network (WWAN). As such, the coverage area of the low power base station can be substantially smaller than the coverage area of a macro base station. Moreover, for example, low power base stations can be deployed in user homes, offices, other venues, utility polls, public transit, and/or substantially any area to serve a number of devices. For example, a given low power base station may use a smaller scale antenna array that may be attached to a housing for the base station or to a common mounting platform.

As used in this application, the terms “component,” “module,” “system” and the like are intended to include a computer-related entity, such as but not limited to hardware, firmware, a combination of hardware and software, software, or software in execution, etc. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE), etc. A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, a tablet, a smart book, a netbook, or other processing devices connected to a wireless modem, etc. Moreover, various aspects are described herein in connection with a base station. A base station may be utilized for communicating with wireless terminal(s) and may also be referred to as an access point, a Node B, evolved Node B (eNB), or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE/LTE-Advanced and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

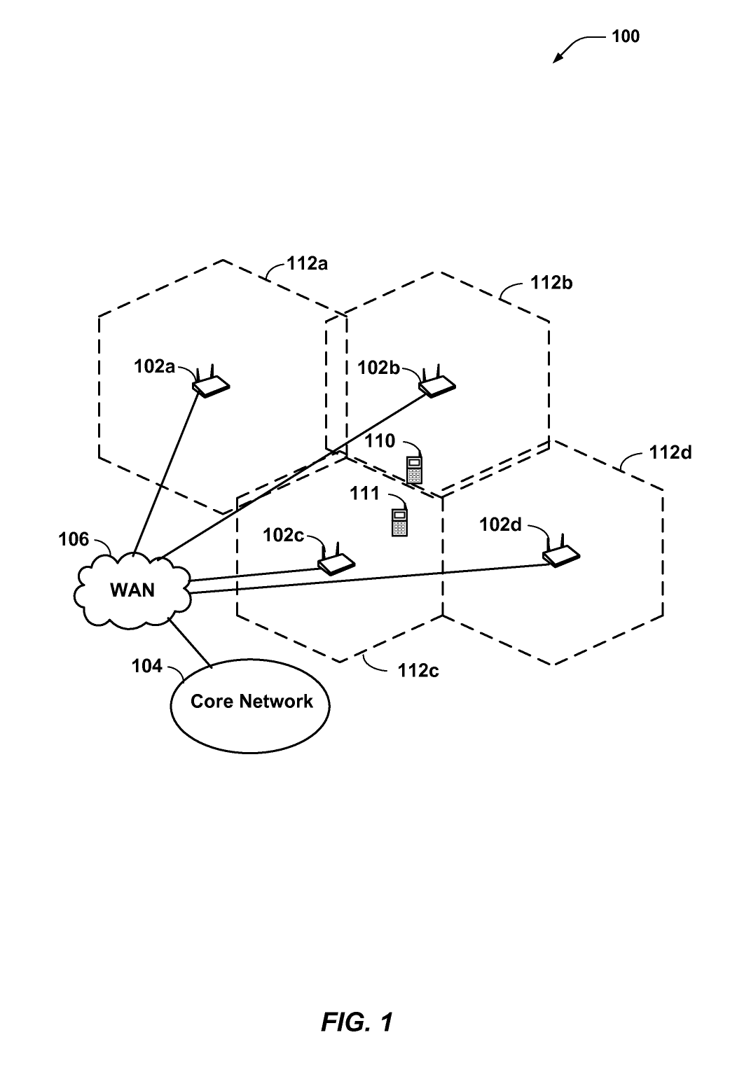

FIG. 1 illustrates an example wireless communications system 100 including a plurality of femto nodes 102a-d, or other low power base stations, in communication with an operator core network 104 via a WAN 106. As described, femto nodes 102a-d may comprise relatively low power equipment and may not be provided with a conventional transmission tower. Each femto node 102a-d may be installed and activated in arbitrary chronological order, at an unplanned location. For example, a network operator may provide femto nodes to various different third parties. While the network operator may install and operate some femto nodes in the system 100, each femto node may be autonomously controlled as described herein, and can be added and removed from the system 100 in a flexible, ad-hoc manner.

Each of the activated femto nodes 102a-d may provide service to UEs, such as UEs 110 and 111, located within corresponding coverage areas 112a-d. For example, a coverage area 112a may be provided by femto node 102a, and so forth. It should be appreciated that coverage areas 112a-d may not have a regular or uniform geometrical shape, and may vary in shape and extent based on local factors such as topology of the landscape and the presence or absence of blocking objects in an area.

In the depicted example, femto node 102b can serve UE 110, which is near a coverage area 112c of femto node 102c. In an example, communications of UE 110 can interfere with communications of femto node 102c and/or UEs served by femto node 102c, such as UE 111. To mitigate such interference, for example, femto node 102b can set a threshold RoT, and control a scheduled load for UE 110 and other served UEs based on achieving the threshold RoT. RoT can relate to the ratio of received signal power from the served UEs to the observed thermal noise at femto node 102b. This ratio can be a reliable indicator of the overall interference level and system stability, for example. In addition, for example, the scheduled load can be utilized when allocating resources to one or more UEs communicating with the femto node 102b. In one example, a number of resources can be allocated such that the scheduled load is not exceeded.

Moreover, as described herein, femto node 102b can set its scheduled uplink load to achieve a RoT relative to the threshold at a specified probability (referred to herein as target RoT tail probability). For example, RoT tail probability can be defined as Prob(RoT>RoTₜₕᵣₑₛ) RoT is a measured RoT of UE 110 and/or other served UEs, and RoTₜₕᵣₑₛ is a determined threshold RoT for femto node 102b. In this regard, femto node 102b can set a scheduled load to achieve a certain target RoT tail probability, and can increase or decrease the scheduled load by a step size based on comparing RoT to RoTₜₕᵣₑₛ in a given time period to achieve the target RoT tail probability. Though described above and herein in terms of RoT, it is to be appreciated that femto node 102b can set scheduled load to similarly achieve a threshold in-cell load (e.g., where femto node 102b RoT is at a threshold RoT) or a target tail probability thereof, a threshold joint RoT and in-cell load or a target tail probability thereof, and/or the like.

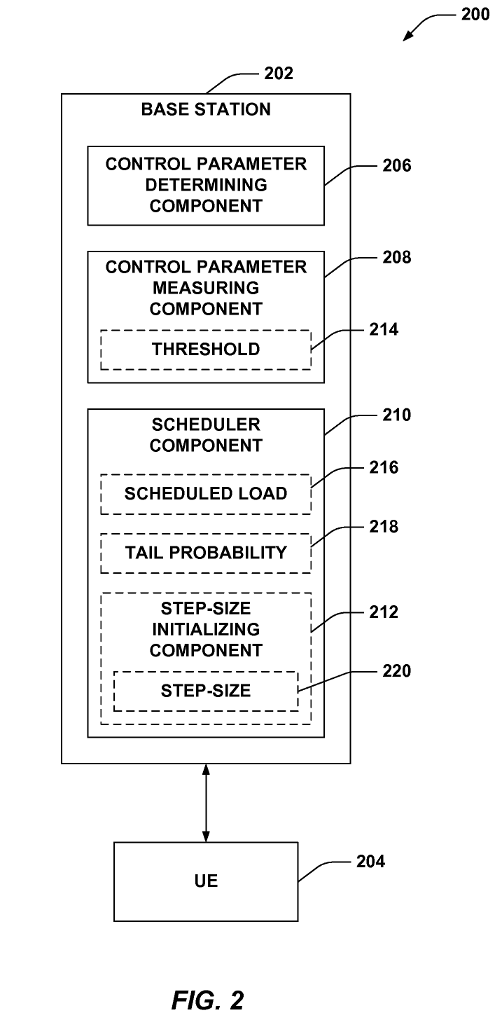

Referring to FIG. 2, an example wireless communication system 200 is illustrated that facilitates setting a scheduled load according to one or more control parameters. System 200 comprises a base station 202 that can be deployed in a wireless network and can provide one or more devices, such as UE 204, with access thereto. For example, base station 202 can be substantially any type of base station, such as a macro node, femto node, or pico node, a relay, a mobile base station, a UE (e.g., communicating in peer-to-peer or ad-hoc mode with UE 204), a portion thereof, and/or substantially any network node that schedules radio resources for wirelessly communicating with UE 204 and/or one or more other UEs. UE 204 can be a mobile device, a stationary device, a modem (or other tethered device), a portion thereof, and/or the like.

Base station 202 can include a control parameter determining component 206 for obtaining one or more control parameters related to signals observed by base station 202 in a wireless network, a control parameter measuring component 208 for comparing the one or more control parameters to one or more thresholds, and a scheduler component 210 for adjusting a scheduled load for receiving communications from one or more UEs based on the compared control parameters. Scheduler component 210 can optionally include a step-size initializing component 212 for setting or otherwise modifying step-sizes for adjusting the scheduled load.

According to an example, scheduler component 210 can adjust an uplink scheduled load 216 of base station 202 based at least in part on observed control parameters, such as RoT, in-cell load, joint RoT and in-cell load, and/or the like. For example, scheduler component 210 can set scheduled load 216 for a specific time period where base station 202 assigns communication resources over one or more time periods (e.g., as one or more portions of frequency over the time periods). In this example, control parameter determining component 206 can determine a RoT, in-cell load, etc., for a given time period, control parameter measuring component 208 can compare the RoT, in-cell load, etc., to a given threshold 214, and scheduler component 210 can accordingly determine whether to adjust a scheduled load 216 for at least one subsequent time period based on the comparison. For example, adjusting the schedule load 216 can include increasing or decreasing the scheduled load 216 by a step-size 220 based on comparing the RoT, in-cell load, etc. to threshold 214. For example, step-size 220 can include a step-size increase value 220 and/or a step-size decrease value 220.

In one specific example, in an orthogonal frequency division multiplexing (OFDM) system, frequency resources can be assigned over one or more time transmit intervals (TTI), which can correspond to fixed length time periods comprising at least a portion of one or more communication frames and including one or more OFDM symbols. In this example, control parameter determining component 206 can measure the RoT for a given time period, such as a TTI, as a total received power, Io(n), over noise power, No(n), where n represents an index of the time period (e.g., a symbol, a slot comprising multiple symbols, etc.):

RoT(n)=Io(n)/No(n)

The power and noise can be measured using a transceiver of base station 202 (e.g., as a decibel (dB) measurement). For example, control parameter measuring component 208 can compare the RoT to a threshold 214 RoT specified for base station 202. The threshold 214 RoT, in this example, can relate to a maximum RoT allowed at base station 202 and can be received by the control parameter measuring component 208 from a hardcoding, configuration (e.g., from a core network component), etc., or otherwise determined by the control parameter measuring component 208 (e.g., based at least in part on historical values for threshold 214).

For example, the RoT can be filtered in time to provide a more robust comparison (e.g., RoT near a slot boundary can be removed from consideration since RoT may be low during these times). In addition, for example, where base station 202 communicates over multiple antennas, a maximum RoT across all antennas can be measured by control parameter determining component 206 for comparing to threshold 214. Where control parameter measuring component 208 determines that the RoT measured by control parameter determining component 206 exceeds the threshold 214, for example, scheduler component 210 can decrease the scheduled load 216 for a subsequent time period by a step-size 220. Where control parameter measuring component 208 determines that the RoT measured by control parameter determining component 206 is less than the threshold 214, for example, scheduler component 210 can increase the scheduled load 216 for a subsequent time period by a step-size 220. This can occur at each slot boundary, for example. The following formula can be used by scheduler component 210, in one example:

$${L}_{sched} ( n ) = \{ \begin{matrix}{L}_{sched} ( n - 1 ) - {Δ}_{down} , & if RoT ( n ) > {RoT}_{thres} \\ {L}_{sched} ( n - 1 ) + {Δ}_{up} , & otherwise\end{matrix}$$

where L_{sched} is the scheduled load 216, n is a current time period, n−1 is the previous time period, Δ_{down} is a step-size decrease value 220, and Δᵤₚ is a step-size increase value 220. In one specific example, scheduler component 210 can initialize scheduled load 216 as:

$${L}_{sched} ( n ) = α \times ( 1 - \frac{1}{{RoT}_{thres}} ) , \\ where 0 \leq α \leq 1$$

where α is a configurable parameter for determining how aggressively to assign the initial scheduled load based on the RoT threshold. Moreover, α can be a parameter that is hardcoded at base station 202, received in a configuration from a network component (not shown), and/or the like. In any case, α can be configured at base station 202 before performing scheduled load adjustment.

If all UEs served by base station 202, such as UE 204, have the same transmission time interval (TTI) with synchronized boundaries, an RoT tail probability 218 can converge to the following limit if achievable by controlling scheduled load 216:

$$Prob ( RoT > {RoT}_{thres} ) -> \frac{{Δ}_{up}}{{Δ}_{up} + {Δ}_{down}}$$

For example, assuming the channel type is additive white Gaussian noise (AWGN) for all UEs served by base station 202, and the background interference plus noise has constant power, the RoT fluctuates at the slot boundaries because UE data blocks are aligned in time with the channel, UE transmit power, and interference constant in each block. Moreover, the total scheduled load 216 can be updated at every slot boundary, and therefore, each decrease (or increase) of the scheduled load 216 can correspond to an event of the RoT being above (or below) the corresponding threshold 214 at the slot boundary. If the total scheduled load fluctuates in a bounded range, as described below, an RoT tail probability 218 Prob(RoT>RoTₜₕᵣₑₛ) can converge to a limit determined by up and down step sizes 220 Δᵤₚ and Δ_{down}.

For instance, where total scheduled load at time zero is S(0) and a Qth adjustment step is S(Q), then within the Q steps, there are N up steps and hence (Q−N) down steps. Thus, S(Q) can be expressed as:

S(Q)=NΔᵤₚ−(Q−N)Δ_{down}+S(0)

Because each down step has a 1-to-1 mapping to an event of RoT exceeding the corresponding threshold, the RoT tail probability 218 at the Qth step can be expressed:

$$Prob ( RoT > {RoT}_{thres} ) = \frac{Q - N}{Q} = \frac{{Δ}_{up}}{{Δ}_{up} + {Δ}_{down}} - \frac{S ( Q ) - S ( 0 )}{Q ( {Δ}_{up} + {Δ}_{down} )}$$

Because the total scheduled load 216 can be bounded, as described below, |S(Q)−S(0)| is also bounded. Therefore, as Q increases, the RoT tail probability 218 can converge to:

$$Prob ( RoT > {RoT}_{thres} ) {->}^{Q -> + ∞} \frac{{Δ}_{up}}{{Δ}_{up} + {Δ}_{down}}$$

In this regard, step-size initializing component 212 can set step-size increase and/or decrease values 220, such as Δᵤₚ and Δ_{down}, to achieve the target tail probability 218 Prob(RoT>RoTₜₕᵣₑₛ). For example, the target tail probability 218 can be set by the scheduler component 210, which can be a configured or hardcoded parameter, an operator specified parameter, a parameter computed from historical performance measurements of base station 202 (e.g., average UE throughput when using given target tail probabilities), and/or the like. Step-size initializing component 212 can obtain the target tail probability 218 for setting step-sizes 220. In a specific example, where the target tail probability 218 for RoT is 1%, step-size initializing component 212 can set step-size increase value 220, Δᵤₚ as:

$${Δ}_{up} = \frac{1}{1 - {RoT}_{tail}} {Δ}_{down}$$

where RoTₜₐᵢₗ is the tail probability (e.g., 1%), and step-size decrease value 220, Δ_{down} is a hardcoded or otherwise configured parameter (e.g., measured linearly) at base station 202. Moreover, for example, Δ_{down} can be modified by one or more network components and provisioned to base station 202. Step-size initializing component 212 can accordingly receive Δ_{down} in this example. Alternatively, step-size initializing component 212 can obtain Δᵤₚ and compute Δ_{down} based on Δᵤₚ, e.g., as Δ_{down}=(1−RoTₜₐᵢₗ)Δᵤₚ. It is to be appreciated that scheduler component 210 can adjust or otherwise update the target tail probability 218, and step-size initializing component 212 can accordingly modify step-sizes 220 to achieve the target tail probability 218.

Moreover, for example, scheduler component 210 can compute scheduled load 216 according to a maximum or minimum value to prevent undesired variation among base stations. For instance, scheduler component 210 can use the following formula:

L_{sched}(n)=max(Bₘᵢₙ,min(L_{sched}(n),Bₘₐₓ))

where 0≦Bₘᵢₙ≦Bₘₐₓ≦1, Bₘᵢₙ is the minimum scheduled load 216, and Bₘₐₓ is the maximum scheduled load. For example, Bₘᵢₙ and Bₘₐₓ can be configured or otherwise hardcoded parameters at scheduler component 210.

In another example, control parameter determining component 206 can obtain an in-cell load measured based on one or more signals received in a time period, and control parameter measuring component 208 can compare the in-cell load to a threshold 214 in-cell load. In this example, scheduler component 210 can set the scheduled load 216 based at least in part on the comparison. In one example, where base station 202 is a femto node at the edge of a macro node coverage area, control parameter measuring component 208 can set the threshold 214 RoT to a relatively high value to increase tolerance to out-of-cell interference caused by nearby UEs communicating with the macro node. In this case, for example (e.g., where threshold 214 RoT is set at least at a given level, such as a threshold RoT), control parameter measuring component 208 can determine to compare in-cell load for setting scheduled load 216 at scheduler component 210 instead of RoT to prevent UEs served by base station 202, such as UE 204, from filling the high threshold RoT in the absence of out-of-cell interference. For example, control parameter determining component 206 can compute the in-cell load in an nth slot (or other time period) as:

$$InL ( n ) = {\sum }_{i} \frac{{Ec}_{i} ( n )}{Io ( n )}$$

where Ecᵢ(n) denotes the received power at an ith in-cell antenna of base station 202 across all served UEs (e.g., UE 204).

In this example, scheduled load 216 can be computed at each slot based on the following:

$${L}_{sched} ( n ) = \{ \begin{matrix}{L}_{sched} ( n - 1 ) - {Δ}_{down} , & if InL ( n ) > {InL}_{thres} \\ {L}_{sched} ( n - 1 ) + {Δ}_{up} , & otherwise\end{matrix}$$

where InLₜₕᵣₑₛ is the threshold 214 in-cell load. Moreover, similar to RoT, the in-cell load tail probability 218 can converge to a limit if achievable by controlling scheduled load 216:

$$Prob ( InL > {InL}_{thres} ) -> \frac{{Δ}_{up}}{{Δ}_{up} + {Δ}_{down}}$$

Thus, step-size initializing component 212 can accordingly determine step-sizes 220 based on the target in-cell load tail probability 218. Moreover, as described with respect to RoT above, the in-cell load can be filtered in time to improve estimation accuracy. Furthermore, in the case of multiple receive antennas, the maximum in-cell load observed across all antennas can be used as the in-cell load for the purposes of setting the scheduled load 216.

As described, control parameters can be extended to additionally or alternatively include a joint RoT and in-cell load. Thus, control parameter determining component 206 can determine both metrics over a period of time (e.g., which can include filtering certain time periods, selecting maximum values over multiple antennas, etc.), and control parameter measuring component 208 can compare the joint RoT and in-cell load to a joint threshold 214. This can include comparing the RoT to a threshold RoT and the in-cell load to a threshold 214 in-cell load. Thus, scheduler component 210 can similarly adjust the scheduled load 216 according to the following formula:

$${L}_{sched} ( n ) = \{ \begin{matrix}{L}_{sched} ( n - 1 ) - {Δ}_{down} , & if RoT ( n ) > {RoT}_{thres} or InL > {InL}_{thres} \\ {L}_{sched} ( n - 1 ) + {Δ}_{up} , & otherwise\end{matrix}$$

Moreover, as described with respect to RoT above, the joint RoT and in-cell load can be filtered in time by control parameter determining component 206 to improve estimation accuracy. Furthermore, in the case of multiple receive antennas, the maximum joint RoT and in-cell load observed across all antennas can be used as the joint RoT and in-cell load for the purposes of setting the scheduled load 216. Additionally, a tail probability 218 of the joint RoT and in-cell load can converge to the limit based on step-sizes 220, and step-size initializing component 212 can similarly set step-sizes based on a target joint RoT and in-cell load tail probability 218.

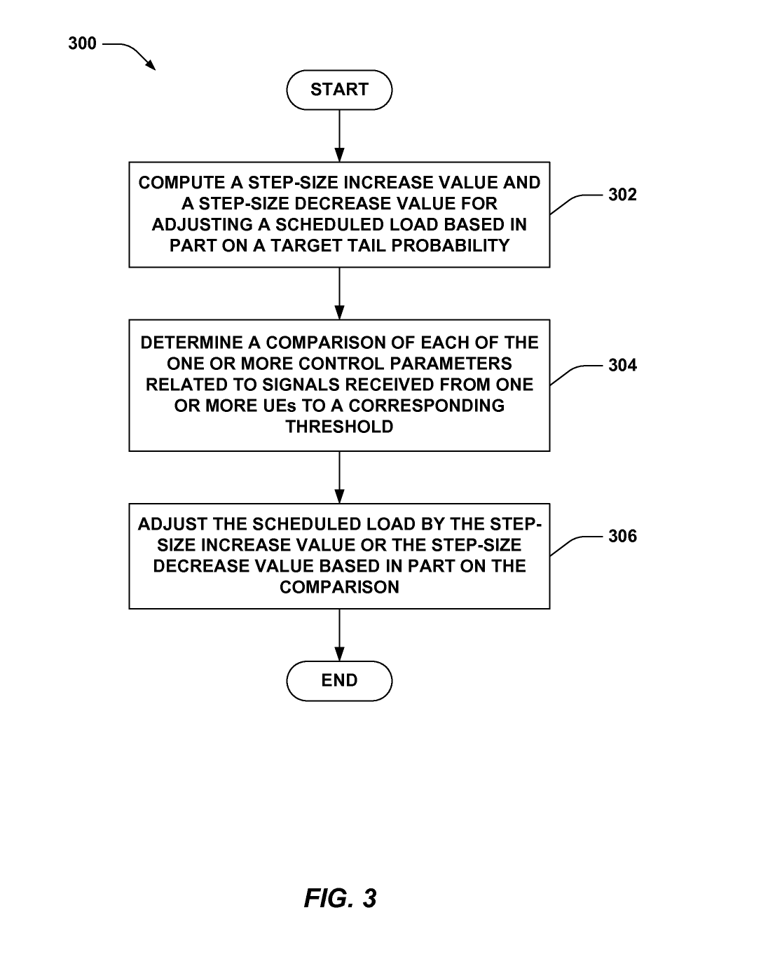

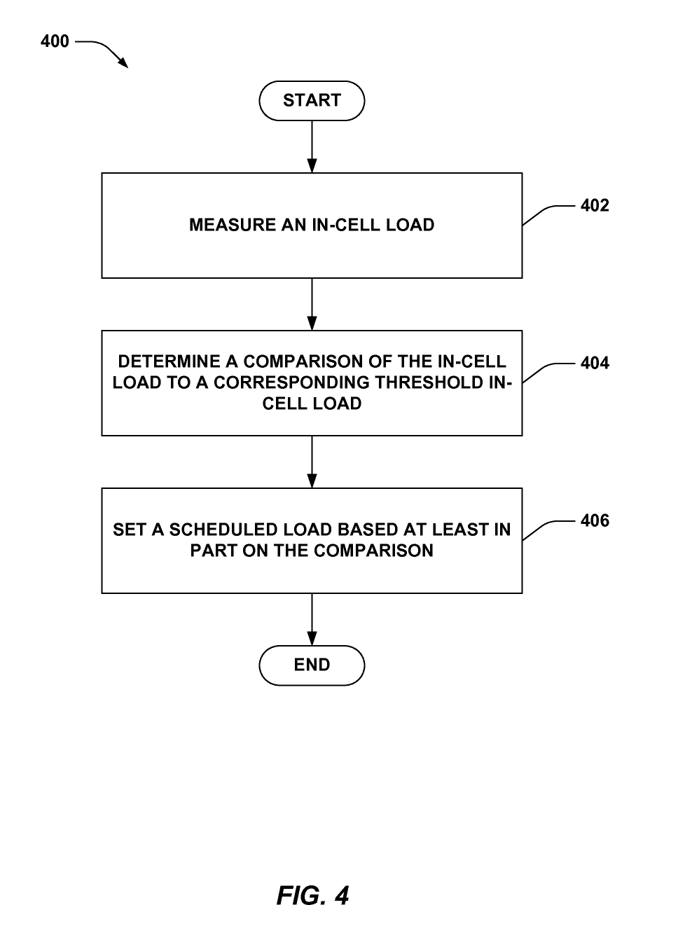

FIGS. 3-4 illustrate example methodologies relating to setting a scheduled load for a base station based on observed control parameters. While, for purposes of simplicity of explanation, the methodologies are shown and described as a series of acts, it is to be understood and appreciated that the methodologies are not limited by the order of acts, as some acts may, in accordance with one or more embodiments, occur concurrently with other acts and/or in different orders from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

FIG. 3 depicts an example methodology 300 for adjusting scheduled load based on one or more measured control parameters. In one example, the methodology 300 can be performed by a femto node 102a-d, a base station 202, or related components, processors, etc.

At 302, a step-size increase value and a step-size decrease value for adjusting a scheduled load can be computed based in part on a target tail probability. The target tail probability can correspond to a RoT target tail probability, an in-cell load target tail probability, a joint RoT and in-cell load target tail probability, and/or the like. Moreover, the target tail probability can be a configured or hardcoded value, a value determined from performance metrics related to other target tail probabilities, and/or the like. The step-size increase value and step-size decrease value can be computed to achieve the target tail probability, as described.

At 304, a comparison of each of the one or more control parameters related to signals received from one or more UEs to a corresponding threshold can be determined. For example, this can include determining whether each of the one or more control parameters exceed a threshold. The thresholds can similarly be hardcoded or otherwise configured, determined from performance metrics related to other values for the threshold, and/or the like.

At 306, the scheduled load can be adjusted by the step-size increase value or the step-size decrease value based in part on the comparison. For example, where the one or more control parameters are over the corresponding threshold at 304, the scheduled load can be adjusted by the step-size decrease value at 306; where the one or more control parameters are under the corresponding threshold at 304, the scheduled load can be adjusted by the step-size increase value at 306.

FIG. 4 illustrates an example methodology 400 for setting a scheduled load based on a measured in-cell load. In one example, the methodology 400 can be performed by femto nodes 102a-d, base station 202, or related components, processors, etc.

At 402, an in-cell load can be measured. For example, this can include measuring a received power at a given antenna of a base station over a total received power at the base station during a period of time.

At 404, a comparison of the in-cell load to a corresponding threshold in-cell load can be determined. As described, the threshold in-cell load can be a hardcoded or configured parameter, determined based on historical performance metrics using other threshold in-cell load values, and/or the like.

At 406, the scheduled load can be set for the base station based at least in part on the comparison. For instance, where the in-cell load is under the threshold in-cell load, the scheduled load can be increased (e.g., by a step-size increase value, as described); where the in-cell load is over the threshold in-cell load, the scheduled load can be decreased (e.g., by a step-size decreased value, as described).

It will be appreciated that, in accordance with one or more aspects described herein, inferences can be made regarding determining thresholds for control parameters, determining step-size values based on tail probabilities, and/or the like, as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

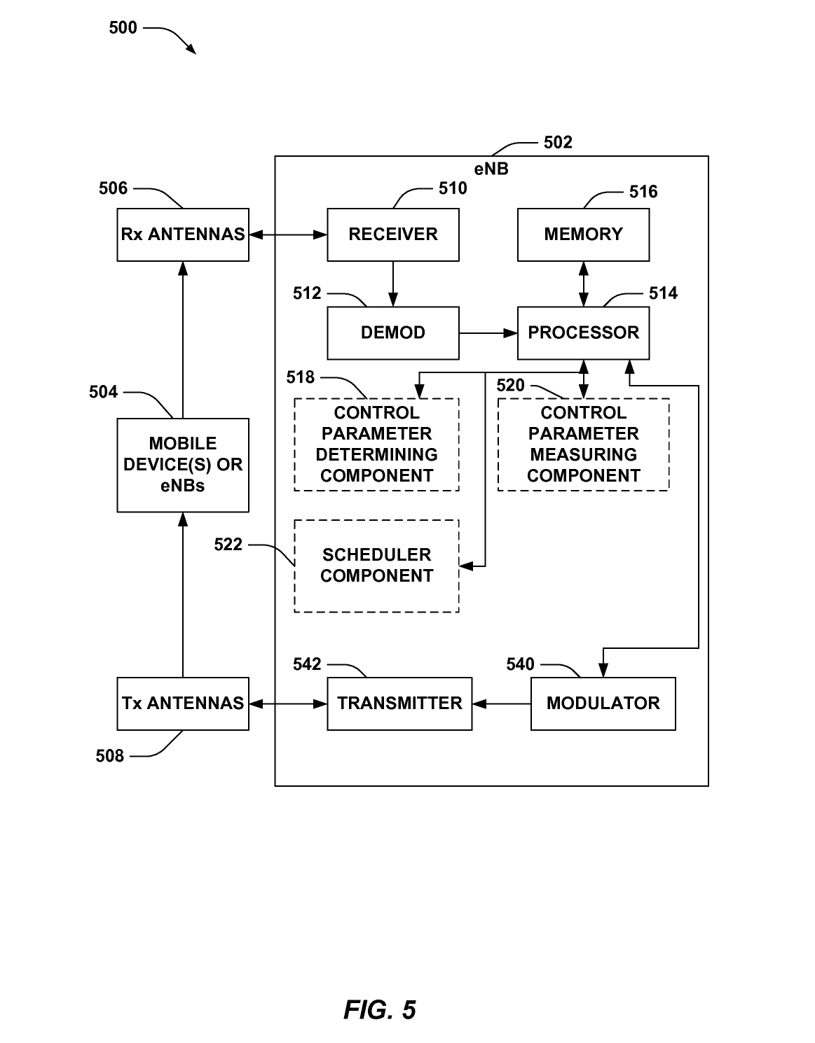

FIG. 5 is an illustration of a system 500 that facilitates adjusting a scheduled load based on control parameters. System 500 includes a eNB 502 having a receiver 510 that receives signal(s) from one or more mobile devices or eNBs 504 through a plurality of receive antennas 506 (e.g., which can be of multiple network technologies), and a transmitter 542 that transmits to the one or more mobile devices or eNBs 504 through a plurality of transmit antennas 508 (e.g., which can be of multiple network technologies). For example, eNB 502 can transmit signals received from eNBs 504 to other eNBs 504, and/or vice versa. Receiver 510 can receive information from one or more receive antennas 506 and is operatively associated with a demodulator 512 that demodulates received information. In addition, in an example, receiver 510 can receive from a wired backhaul link. Though depicted as separate antennas, it is to be appreciated that at least one of receive antennas 506 and a corresponding one of transmit antennas 508 can be combined as the same antenna. Demodulated symbols are analyzed by a processor 514, which is coupled to a memory 516 that stores information related to performing one or more aspects described herein.

Processor 514, for example, can be a processor dedicated to analyzing information received by receiver 510 and/or generating information for transmission by a transmitter 542, a processor that controls one or more components of eNB 502, and/or a processor that analyzes information received by receiver 510, generates information for transmission by transmitter 542, and controls one or more components of eNB 502. In addition, processor 514 can perform one or more functions described herein and/or can communicate with components for such a purpose.

Memory 516, as described, is operatively coupled to processor 514 and can store data to be transmitted, received data, information related to available channels, data associated with analyzed signal and/or interference strength, information related to an assigned channel, power, rate, or the like, and any other suitable information for estimating a channel and communicating via the channel. Memory 516 can additionally store protocols and/or algorithms associated with adjusting a scheduled load of eNB 502.

It will be appreciated that the data store (e.g., memory 516) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 516 of the subject systems and methods is intended to comprise, without being limited to, these and any other suitable types of memory.

Processor 514 is further optionally coupled to a control parameter determining component 518, which can be similar to control parameter determining component 206, a control parameter measuring component 520, which can be similar to control parameter measuring component 208, and/or a scheduler component 522, which can be similar to scheduler component 210, and can comprise one or more further components thereof. Moreover, for example, processor 514 can modulate signals to be transmitted using modulator 540, and transmit modulated signals using transmitter 542. Transmitter 542 can transmit signals to mobile devices or eNBs 504 over Tx antennas 508. Furthermore, although depicted as being separate from the processor 514, it is to be appreciated that the control parameter determining component 518, control parameter measuring component 520, scheduler component 522, demodulator 512, and/or modulator 540 can be part of the processor 514 or multiple processors (not shown), and/or stored as instructions in memory 516 for execution by processor 514.

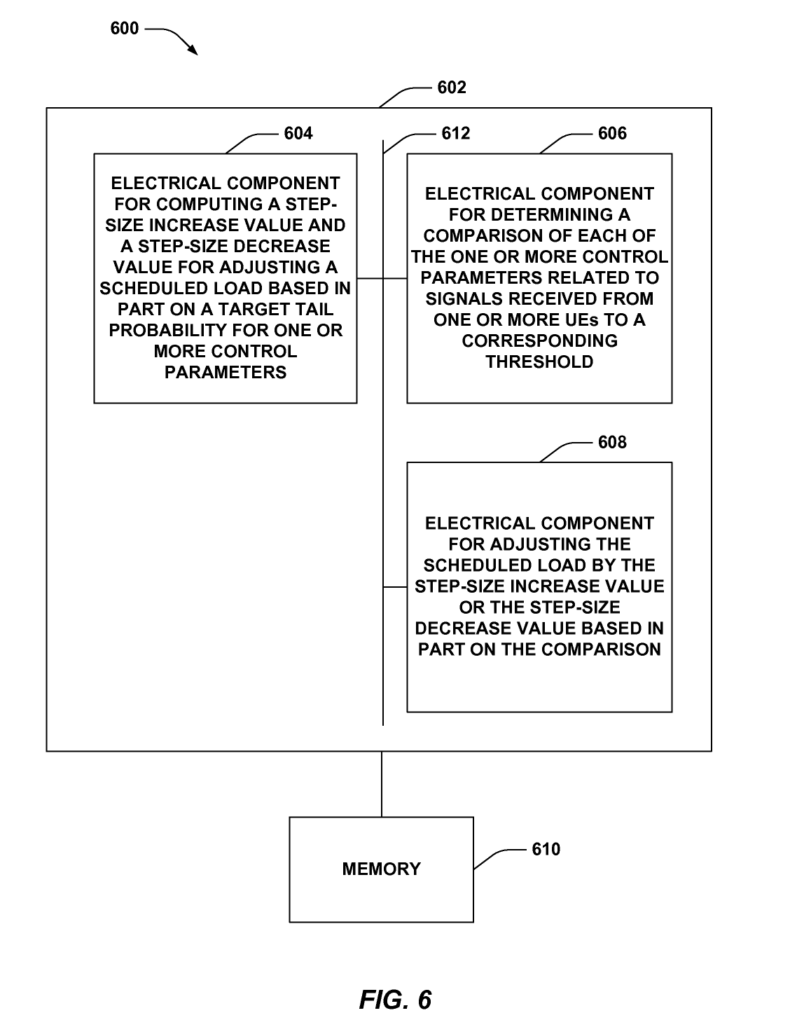

FIG. 6 illustrates a system 600 for adjusting a scheduled load based on one or more control parameters. For example, system 600 can reside at least partially within a femto node or other base station, etc. It is to be appreciated that system 600 is represented as including functional blocks, which can be functional blocks that represent functions implemented by a processor, software, or combination thereof (e.g., firmware). System 600 includes a logical grouping 602 of electrical components that can act in conjunction. For instance, logical grouping 602 can include an electrical component for computing a step-size increase value and a step-size decrease value for adjusting a scheduled load based in part on a target tail probability for one or more control parameters 604. For instance, the step-size values can be adjusted in an attempt to achieve the target tail probability, as described.

Further, logical grouping 602 can include an electrical component for determining a comparison of each of the one or more control parameters related to signals received from one or more UEs to a corresponding threshold 606. Logical grouping 602 can also include an electrical component for adjusting the scheduled load by the step-size increase value or the step-size decrease value based in part on the comparison 608. For example, electrical component 608 can increase the scheduled load where the one or more control parameters are under the corresponding threshold, decrease the scheduled load where the one or more control parameters are over the corresponding threshold, etc.

For example, electrical component 604 can include a step-size initializing component 212, as described above. In addition, for example, electrical component 606, in an aspect, can include a control parameter measuring component 208, and/or electrical component 608 can include a scheduler component 210, as described.

Additionally, system 600 can include a memory 610 that retains instructions for executing functions associated with the electrical components 604, 606, and 608. While shown as being external to memory 610, it is to be understood that one or more of the electrical components 604, 606, and 608 can exist within memory 610. Moreover, for example, electrical components 604, 606, and 608 can be interconnected by a bus 612. In one example, electrical components 604, 606, and 608 can include at least one processor, or each electrical component 604, 606, and 608 can be a corresponding module of at least one processor. Moreover, in an additional or alternative example, electrical components 604, 606, and 608 can be a computer program product comprising a computer readable medium, where each electrical component 604, 606, and 608 can be corresponding code.

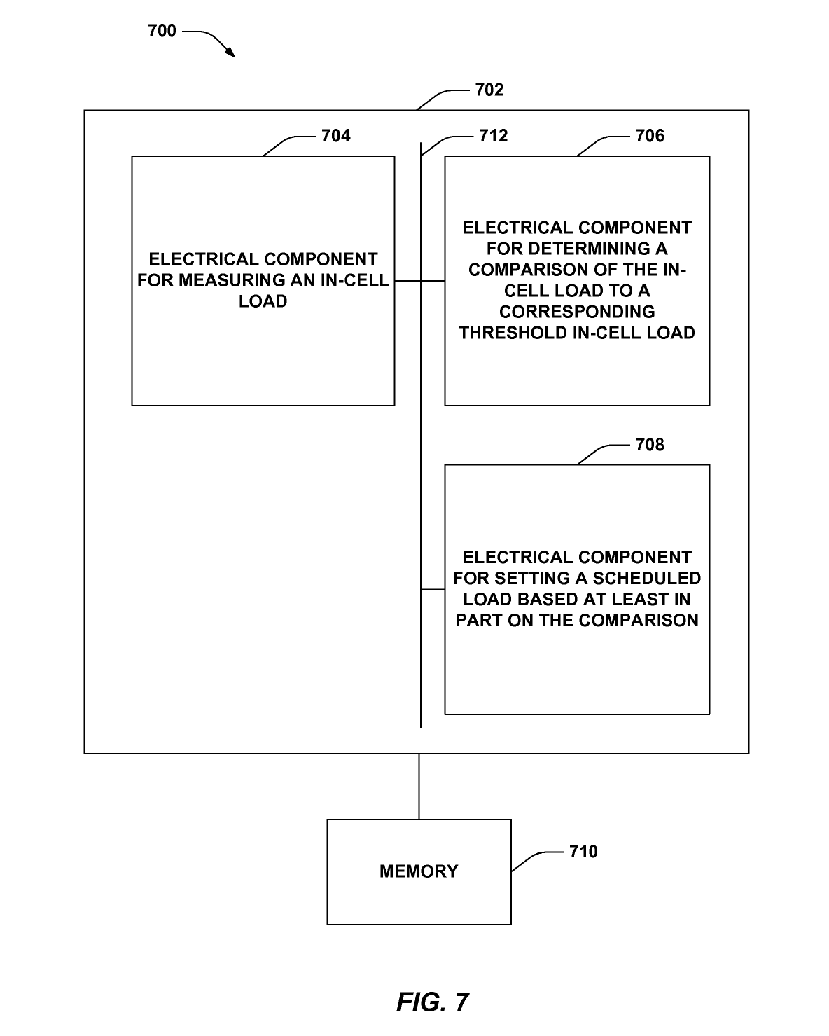

FIG. 7 illustrates a system 700 for adjusting a scheduled load based on an in-cell load. For example, system 700 can reside at least partially within a femto node or other base station, etc. It is to be appreciated that system 700 is represented as including functional blocks, which can be functional blocks that represent functions implemented by a processor, software, or combination thereof (e.g., firmware). System 700 includes a logical grouping 702 of electrical components that can act in conjunction. For instance, logical grouping 702 can include an electrical component for measuring an in-cell load 704. As described, this can include measuring received power at one antenna of a base station over a total received power.

Further, logical grouping 702 can include an electrical component for determining a comparison of the in-cell load to a corresponding threshold in-cell load 706. Logical grouping 702 can also include an electrical component for setting a scheduled load based at least in part on the comparison 708. For example, electrical component 708 can increase the scheduled load where the in-cell load is under the threshold in-cell load, decrease the in-cell load is over the threshold in-cell load, etc.

For example, electrical component 704 can include a control parameter determining component 206, as described above. In addition, for example, electrical component 706, in an aspect, can include a control parameter measuring component 208, and/or electrical component 708 can include a scheduler component 210, as described.

Additionally, system 700 can include a memory 710 that retains instructions for executing functions associated with the electrical components 704, 706, and 708. While shown as being external to memory 710, it is to be understood that one or more of the electrical components 704, 706, and 708 can exist within memory 710. Moreover, for example, electrical components 704, 706, and 708 can be interconnected by a bus 712. In one example, electrical components 704, 706, and 708 can include at least one processor, or each electrical component 704, 706, and 708 can be a corresponding module of at least one processor. Moreover, in an additional or alternative example, electrical components 704, 706, and 708 can be a computer program product comprising a computer readable medium, where each electrical component 704, 706, and 708 can be corresponding code.

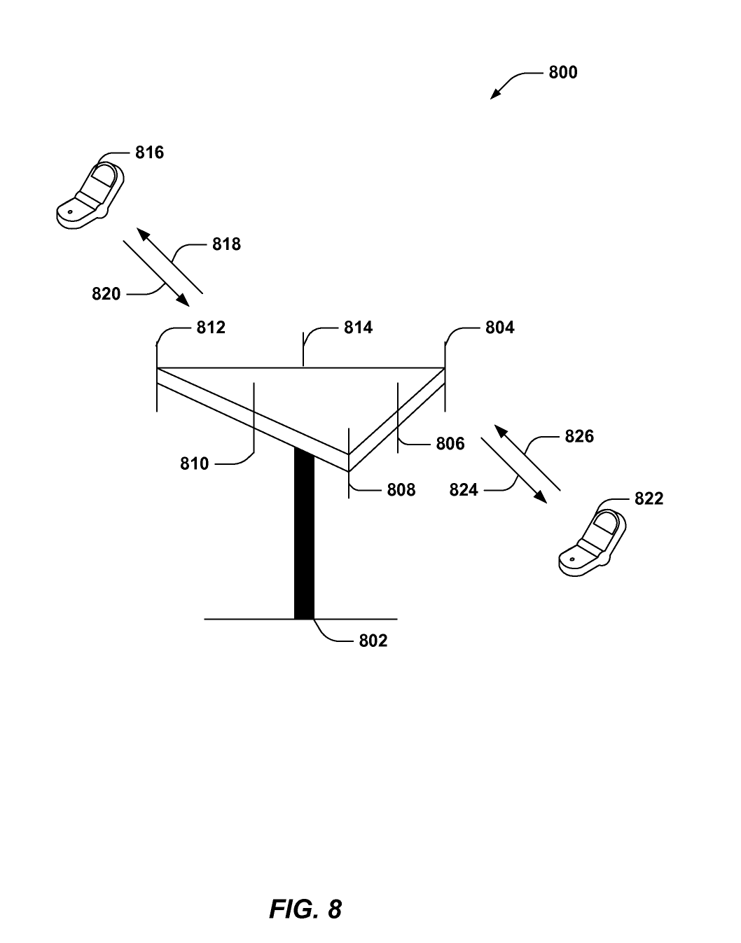

FIG. 8 illustrates a wireless communication system 800 in accordance with various embodiments presented herein. System 800 comprises a base station 802 that can include multiple antenna groups. For example, one antenna group can include antennas 804 and 806, another group can comprise antennas 808 and 810, and an additional group can include antennas 812 and 814. Two antennas are illustrated for each antenna group; however, more or fewer antennas can be utilized for each group. Base station 802 can additionally include a transmitter chain and a receiver chain, each of which can in turn comprise a plurality of components or modules associated with signal transmission and reception (e.g., processors, modulators, multiplexers, demodulators, demultiplexers, antennas, etc.), as is appreciated.

Base station 802 can communicate with one or more mobile devices such as mobile device 816 and mobile device 822; however, it is to be appreciated that base station 802 can communicate with substantially any number of mobile devices similar to mobile devices 816 and 822. Mobile devices 816 and 822 can be, for example, cellular phones, smart phones, laptops, handheld communication devices, handheld computing devices, satellite radios, global positioning systems, PDAs, and/or any other suitable device for communicating over wireless communication system 800. As depicted, mobile device 816 is in communication with antennas 812 and 814, where antennas 812 and 814 transmit information to mobile device 816 over a forward link 818 and receive information from mobile device 816 over a reverse link 820. Moreover, mobile device 822 is in communication with antennas 804 and 806, where antennas 804 and 806 transmit information to mobile device 822 over a forward link 824 and receive information from mobile device 822 over a reverse link 826. In a frequency division duplex (FDD) system, forward link 818 can utilize a different frequency band than that used by reverse link 820, and forward link 824 can employ a different frequency band than that employed by reverse link 826, for example. Further, in a time division duplex (TDD) system, forward link 818 and reverse link 820 can utilize a common frequency band and forward link 824 and reverse link 826 can utilize a common frequency band.

Each group of antennas and/or the area in which they are designated to communicate can be referred to as a sector of base station 802. For example, antenna groups can be designed to communicate to mobile devices in a sector of the areas covered by base station 802. In communication over forward links 818 and 824, the transmitting antennas of base station 802 can utilize beamforming to improve signal-to-noise ratio of forward links 818 and 824 for mobile devices 816 and 822. Also, while base station 802 utilizes beamforming to transmit to mobile devices 816 and 822 scattered randomly through an associated coverage, mobile devices in neighboring cells can be subject to less interference as compared to a base station transmitting through a single antenna to all its mobile devices. Moreover, mobile devices 816 and 822 can communicate directly with one another using a peer-to-peer or ad hoc technology as depicted.

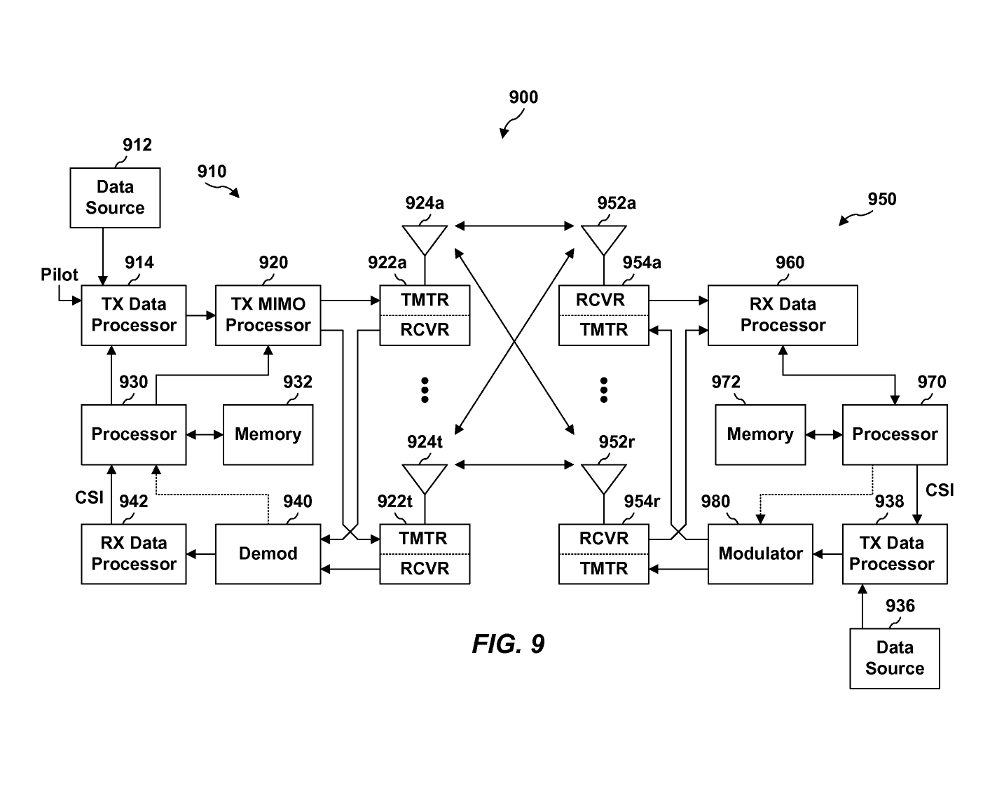

FIG. 9 shows an example wireless communication system 900. The wireless communication system 900 depicts one base station 910 and one mobile device 950 for sake of brevity. However, it is to be appreciated that system 900 can include more than one base station and/or more than one mobile device, wherein additional base stations and/or mobile devices can be substantially similar or different from example base station 910 and mobile device 950 described below. Moreover, base station 910 can be a low power base station, in one example, such as one or more femto nodes previously described. In addition, it is to be appreciated that base station 910 and/or mobile device 950 can employ the example systems (FIGS. 1-2 and 5-8) and/or methods (FIGS. 3-4) described herein to facilitate wireless communication there between. For example, components or functions of the systems and/or methods described herein can be part of a memory 932 and/or 972 or processors 930 and/or 970 described below, and/or can be executed by processors 930 and/or 970 to perform the disclosed functions.

At base station 910, traffic data for a number of data streams is provided from a data source 912 to a transmit (TX) data processor 914. According to an example, each data stream can be transmitted over a respective antenna. TX data processor 914 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 950 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 930.

The modulation symbols for the data streams can be provided to a TX MIMO processor 920, which can further process the modulation symbols (e.g., for OFDM). TX MIMO processor 920 then provides N_{T} modulation symbol streams to N_{T} transmitters (TMTR) 922a through 922t. In various embodiments, TX MIMO processor 920 applies beamforming weights to the symbols of the data streams and to the antenna from which the symbol is being transmitted.

Each transmitter 922 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 922a through 922t are transmitted from N_{T} antennas 924a through 924t, respectively.

At mobile device 950, the transmitted modulated signals are received by N_{R} antennas 952a through 952r and the received signal from each antenna 952 is provided to a respective receiver (RCVR) 954a through 954r. Each receiver 954 conditions (e.g., filters, amplifies, and downconverts) a respective signal, digitizes the conditioned signal to provide samples, and further processes the samples to provide a corresponding “received” symbol stream.

An RX data processor 960 can receive and process the N_{R} received symbol streams from N_{R} receivers 954 based on a particular receiver processing technique to provide N_{T} “detected” symbol streams. RX data processor 960 can demodulate, deinterleave, and decode each detected symbol stream to recover the traffic data for the data stream. The processing by RX data processor 960 is complementary to that performed by TX MIMO processor 920 and TX data processor 914 at base station 910.

The reverse link message can comprise various types of information regarding the communication link and/or the received data stream. The reverse link message can be processed by a TX data processor 938, which also receives traffic data for a number of data streams from a data source 936, modulated by a modulator 980, conditioned by transmitters 954a through 954r, and transmitted back to base station 910.

At base station 910, the modulated signals from mobile device 950 are received by antennas 924, conditioned by receivers 922, demodulated by a demodulator 940, and processed by a RX data processor 942 to extract the reverse link message transmitted by mobile device 950. Further, processor 930 can process the extracted message to determine which precoding matrix to use for determining the beamforming weights.

Processors 930 and 970 can direct (e.g., control, coordinate, manage, etc.) operation at base station 910 and mobile device 950, respectively. Respective processors 930 and 970 can be associated with memory 932 and 972 that store program codes and data. For example, processor 930 and/or 970 can execute, and/or memory 932 and/or 972 can store instructions related to functions and/or components described herein, such as adjusting scheduled load based on measuring control parameters, setting step-size values for adjusting the scheduled load, and/or the like, as described.

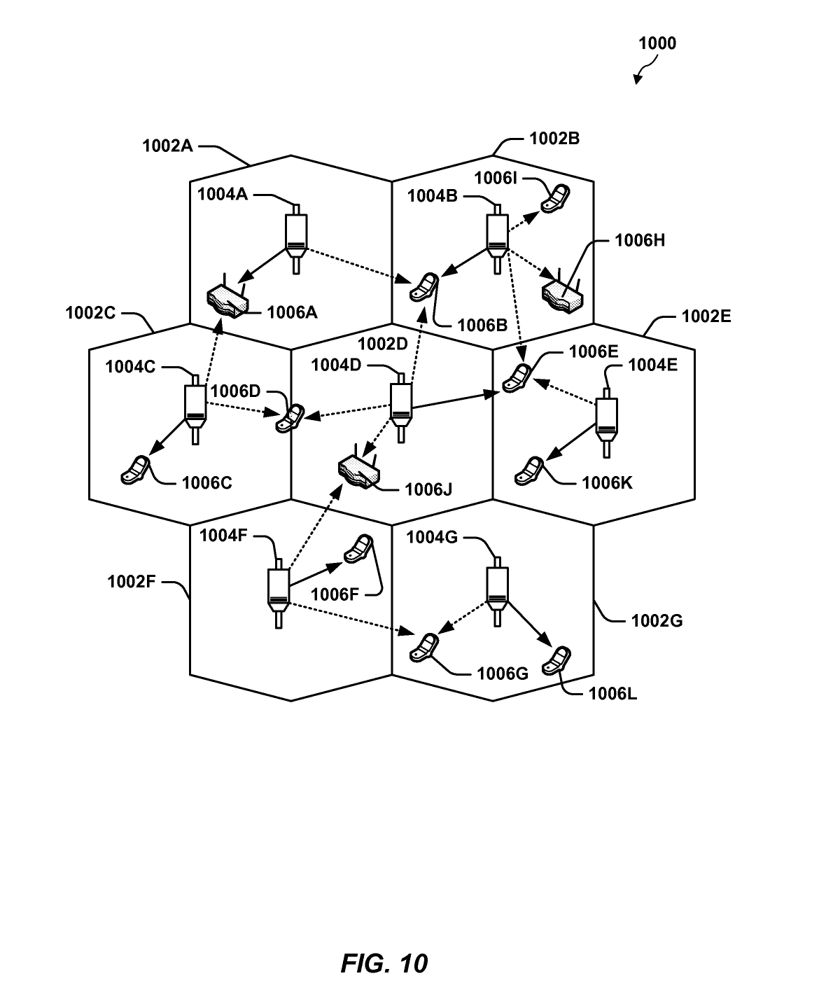

FIG. 10 illustrates a wireless communication system 1000, configured to support a number of users, in which the teachings herein may be implemented. The system 1000 provides communication for multiple cells 1002, such as, for example, macro cells 1002A-1002G, with each cell being serviced by a corresponding access node 1004 (e.g., access nodes 1004A-1004G). As shown in FIG. 10, access terminals 1006 (e.g., access terminals 1006A-1006L) can be dispersed at various locations throughout the system over time. Each access terminal 1006 can communicate with one or more access nodes 1004 on a forward link (FL) and/or a reverse link (RL) at a given moment, depending upon whether the access terminal 1006 is active and whether it is in soft handoff, for example. The wireless communication system 1000 can provide service over a large geographic region.

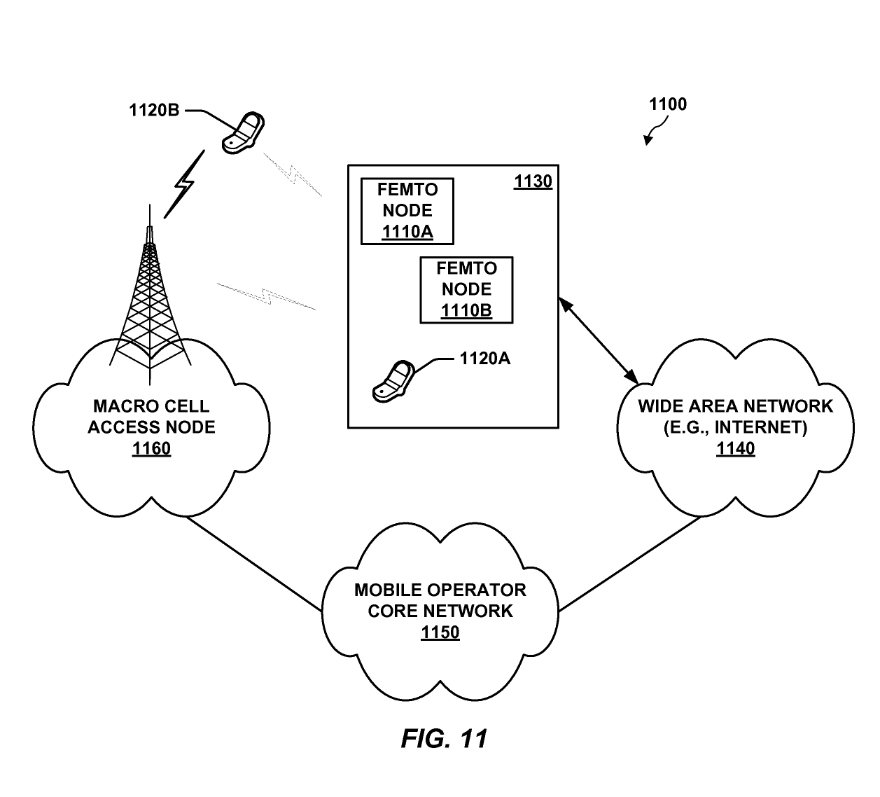

FIG. 11 illustrates an exemplary communication system 1100 where one or more femto nodes are deployed within a network environment. Specifically, the system 1100 includes multiple femto nodes 1110A and 1110B (e.g., femtocell nodes or H(e)NB) installed in a relatively small scale network environment (e.g., in one or more user residences 1130). Each femto node 1110 can be coupled to a wide area network 1140 (e.g., the Internet) and a mobile operator core network 1150 via a digital subscriber line (DSL) router, a cable modem, a wireless link, or other connectivity means (not shown). As will be discussed below, each femto node 1110 can be configured to serve associated access terminals 1120 (e.g., access terminal 1120A) and, optionally, alien access terminals 1120 (e.g., access terminal 1120B). In other words, access to femto nodes 1110 can be restricted such that a given access terminal 1120 can be served by a set of designated (e.g., home) femto node(s) 1110 but may not be served by any non-designated femto nodes 1110 (e.g., a neighbor's femto node).

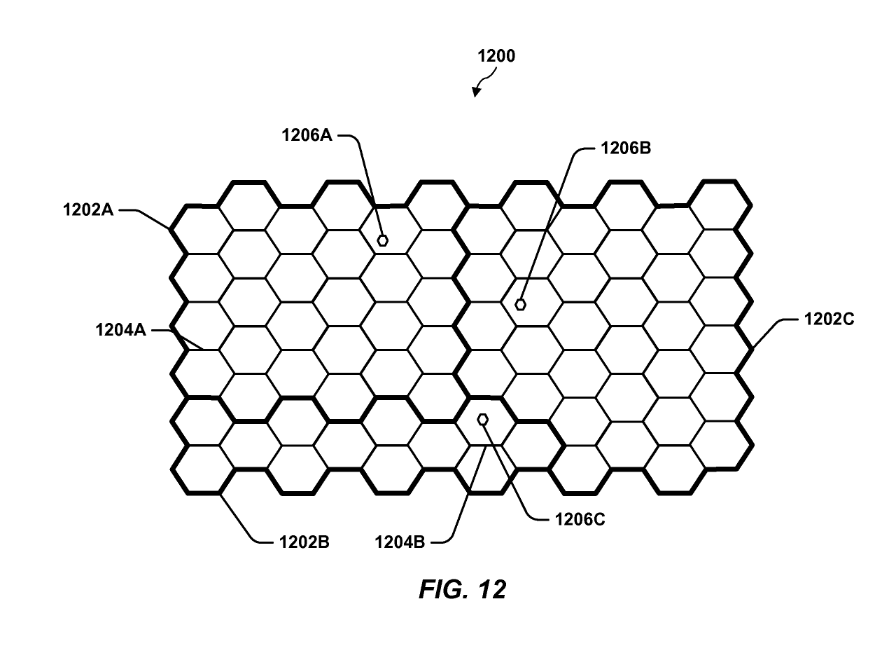

FIG. 12 illustrates an example of a coverage map 1200 where several tracking areas 1202 (or routing areas or location areas) are defined, each of which includes several macro coverage areas 1204. Here, areas of coverage associated with tracking areas 1202A, 1202B, and 1202C are delineated by the wide lines and the macro coverage areas 1204 are represented by the hexagons. The tracking areas 1202 also include femto coverage areas 1206. In this example, each of the femto coverage areas 1206 (e.g., femto coverage area 1206C) is depicted within a macro coverage area 1204 (e.g., macro coverage area 1204B). It should be appreciated, however, that a femto coverage area 1206 may not lie entirely within a macro coverage area 1204. In practice, a large number of femto coverage areas 1206 can be defined with a given tracking area 1202 or macro coverage area 1204. Also, one or more pico coverage areas (not shown) can be defined within a given tracking area 1202 or macro coverage area 1204.

Referring again to FIG. 11, the owner of a femto node 1110 can subscribe to mobile service, such as, for example, 3G mobile service, offered through the mobile operator core network 1150. In addition, an access terminal 1120 can be capable of operating both in macro environments and in smaller scale (e.g., residential) network environments. Thus, for example, depending on the current location of the access terminal 1120, the access terminal 1120 can be served by an access node 1160 or by any one of a set of femto nodes 1110 (e.g., the femto nodes 1110A and 1110B that reside within a corresponding user residence 1130). For example, when a subscriber is outside his home, he is served by a standard macro cell access node (e.g., node 1160) and when the subscriber is at home, he is served by a femto node (e.g., node 1110A). Here, it should be appreciated that a femto node 1110 can be backward compatible with existing access terminals 1120.

A femto node 1110 can be deployed on a single frequency or, in the alternative, on multiple frequencies. Depending on the particular configuration, the single frequency or one or more of the multiple frequencies can overlap with one or more frequencies used by a macro cell access node (e.g., node 1160). In some aspects, an access terminal 1120 can be configured to connect to a preferred femto node (e.g., the home femto node of the access terminal 1120) whenever such connectivity is possible. For example, whenever the access terminal 1120 is within the user's residence 1130, it can communicate with the home femto node 1110.

In some aspects, if the access terminal 1120 operates within the mobile operator core network 1150 but is not residing on its most preferred network (e.g., as defined in a preferred roaming list), the access terminal 1120 can continue to search for the most preferred network (e.g., femto node 1110) using a Better System Reselection (BSR), which can involve a periodic scanning of available systems to determine whether better systems are currently available, and subsequent efforts to associate with such preferred systems. Using an acquisition table entry (e.g., in a preferred roaming list), in one example, the access terminal 1120 can limit the search for specific band and channel. For example, the search for the most preferred system can be repeated periodically. Upon discovery of a preferred femto node, such as femto node 1110, the access terminal 1120 selects the femto node 1110 for camping within its coverage area.

A femto node can be restricted in some aspects. For example, a given femto node can only provide certain services to certain access terminals. In deployments with so-called restricted (or closed) association, a given access terminal can only be served by the macro cell mobile network and a defined set of femto nodes (e.g., the femto nodes 1110 that reside within the corresponding user residence 1130). In some implementations, a femto node can be restricted to not provide, for at least one access terminal, at least one of: signaling, data access, registration, paging, or service.

In some aspects, a restricted femto node (which can also be referred to as a Closed Subscriber Group H(e)NB) is one that provides service to a restricted provisioned set of access terminals. This set can be temporarily or permanently extended as necessary. In some aspects, a Closed Subscriber Group (CSG) can be defined as the set of access nodes (e.g., femto nodes) that share a common access control list of access terminals. A channel on which all femto nodes (or all restricted femto nodes) in a region operate can be referred to as a femto channel.

Various relationships can thus exist between a given femto node and a given access terminal. For example, from the perspective of an access terminal, an open femto node can refer to a femto node with no restricted association. A restricted femto node can refer to a femto node that is restricted in some manner (e.g., restricted for association and/or registration). A home femto node can refer to a femto node on which the access terminal is authorized to access and operate on. A guest femto node can refer to a femto node on which an access terminal is temporarily authorized to access or operate on. An alien femto node can refer to a femto node on which the access terminal is not authorized to access or operate on (e.g., the access terminal is a non-member), except for perhaps emergency situations (e.g., 911 calls).

From a restricted femto node perspective, a home access terminal can refer to an access terminal that authorized to access the restricted femto node. A guest access terminal can refer to an access terminal with temporary access to the restricted femto node. An alien access terminal can refer to an access terminal that does not have permission to access the restricted femto node, except for perhaps emergency situations, for example, 911 calls (e.g., an access terminal that does not have the credentials or permission to register with the restricted femto node).

For convenience, the disclosure herein describes various functionality in the context of a femto node. It should be appreciated, however, that a pico node can provide the same or similar functionality as a femto node, but for a larger coverage area. For example, a pico node can be restricted, a home pico node can be defined for a given access terminal, and so on.

A wireless multiple-access communication system can simultaneously support communication for multiple wireless access terminals. As mentioned above, each terminal can communicate with one or more base stations via transmissions on the forward and reverse links. The forward link (or downlink) refers to the communication link from the base stations to the terminals, and the reverse link (or uplink) refers to the communication link from the terminals to the base stations. This communication link can be established via a single-in-single-out system, a MIMO system, or some other type of system.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for adjusting a scheduled load for one or more user equipment (UE) in a wireless network, comprising:
computing a step-size increase value and a step-size decrease value for adjusting a scheduled load based in part on a target tail probability for one or more control parameters;
determining a comparison of each of the one or more control parameters related to signals received from one or more UEs to a corresponding threshold; and
adjusting the scheduled load by the step-size increase value or the step-size decrease value based in part on the comparison.

2. The method of claim 1, wherein the one or more control parameters correspond to a rise-over-thermal (RoT), and the adjusting comprises one of adjusting the scheduled load by the step-size decrease value where the RoT is over the corresponding threshold or adjusting the scheduled load by the step-size increase value where the RoT is under the corresponding threshold.

3. The method of claim 1, wherein the one or more control parameters correspond to an in-cell load, and the adjusting comprises one of adjusting the scheduled load by the step-size decrease value where the in-cell load is over the corresponding threshold or adjusting the scheduled load by the step-size increase value where the in-cell load is under the corresponding threshold.

4. The method of claim 1, wherein the one or more control parameters correspond to a rise-over-thermal (RoT) and an in-cell load, and the adjusting comprises one of adjusting the scheduled load by the step-size decrease value where either the RoT or the in-cell load is over the corresponding threshold, or adjusting the scheduled load by the step-size increase value where the RoT and the in-cell load are under the corresponding threshold.

5. The method of claim 1, further comprising obtaining the target tail probability from a hardcoding or configuration.

6. The method of claim 1, further comprising updating the step-size increase value or the step-size decrease value based on receiving a modified target tail probability.

7. The method of claim 1, wherein the computing the step-size increase value comprises multiplying the step-size decrease value by the target tail probability for the one or more control parameters.

8. An apparatus for adjusting a scheduled load for one or more user equipment (UE) in a wireless network, comprising:
at least one processor configured to:
compute a step-size increase value and a step-size decrease value for adjusting a scheduled load based in part on a target tail probability for one or more control parameters;
determine a comparison of each of the one or more control parameters related to signals received from one or more UEs to a corresponding threshold; and
adjust the scheduled load by the step-size increase value or the step-size decrease value based in part on the comparison; and
a memory coupled to the at least one processor.

9. The apparatus of claim 8, wherein the one or more control parameters correspond to a rise-over-thermal (RoT), and the at least one processor adjusts the scheduled load by the step-size decrease value where the RoT is over the corresponding threshold, or by the step-size increase value where the RoT is under the corresponding threshold.

10. The apparatus of claim 8, wherein the one or more control parameters correspond to an in-cell load, and the at least one processor adjusts the scheduled load by the step-size decrease value where the in-cell load is over the corresponding threshold, or by the step-size increase value where the in-cell load is under the corresponding threshold.

11. The apparatus of claim 8, wherein the one or more control parameters correspond to a rise-over-thermal (RoT) and an in-cell load, and the at least one processor adjusts scheduled load by the step-size decrease value where either the RoT or the in-cell load is over the corresponding threshold, or by the step-size increase value where the RoT and the in-cell load are under the corresponding threshold.

12. The apparatus of claim 8, wherein the at least one processor is further configured to obtain the target tail probability from a hardcoding or configuration.

13. The apparatus of claim 8, wherein the at least one processor is further configured to update the step-size increase value or the step-size decrease value based on receiving a modified target tail probability.

14. The apparatus of claim 8, wherein the at least one processor computes the step-size increase value by multiplying the step-size decrease value by the target tail probability for the one or more control parameters.

15. An apparatus for adjusting a scheduled load for one or more user equipment (UE) in a wireless network, comprising:
means for computing a step-size increase value and a step-size decrease value for adjusting a scheduled load based in part on a target tail probability for one or more control parameters;
means for determining a comparison of each of the one or more control parameters related to signals received from one or more UEs to a corresponding threshold; and
means for adjusting the scheduled load by the step-size increase value or the step-size decrease value based in part on the comparison.

16. The apparatus of claim 15, wherein the one or more control parameters correspond to a rise-over-thermal (RoT), and the means for adjusting adjusts the scheduled load by the step-size decrease value where the RoT is over the corresponding threshold, or by the step-size increase value where the RoT is under the corresponding threshold.

17. The apparatus of claim 15, wherein the one or more control parameters correspond to an in-cell load, and the means for adjusting adjusts the scheduled load by the step-size decrease value where the in-cell load is over the corresponding threshold, or by the step-size increase value where the in-cell load is under the corresponding threshold.

18. The apparatus of claim 15, wherein the one or more control parameters correspond to a rise-over-thermal (RoT) and an in-cell load, and the means for adjusting adjusts scheduled load by the step-size decrease value where either the RoT or the in-cell load is over the corresponding threshold, or by the step-size increase value where the RoT and the in-cell load are under the corresponding threshold.

19. The apparatus of claim 15, wherein the means for computing obtains the target tail probability from a hardcoding or configuration.

20. The apparatus of claim 15, wherein the means for computing updates the step-size increase value or the step-size decrease value based on receiving a modified target tail probability.

21. The apparatus of claim 15, wherein the means for computing computes the step-size increase value by multiplying the step-size decrease value by the target tail probability for the one or more control parameters.

22. A computer program product for adjusting a scheduled load for one or more user equipment (UE) in a wireless network, comprising:
a non-transitory computer-readable medium, comprising:
code for causing at least one computer to compute a step-size increase value and a step-size decrease value for adjusting a scheduled load based in part on a target tail probability for one or more control parameters;
code for causing the at least one computer to determine a comparison of each of the one or more control parameters related to signals received from one or more UEs to a corresponding threshold; and
code for causing the at least one computer to adjust the scheduled load by the step-size increase value or the step-size decrease value based in part on the comparison.

23. The computer program product of claim 22, wherein the one or more control parameters correspond to a rise-over-thermal (RoT), and the code for causing the at least one computer to adjust adjusts the scheduled load by the step-size decrease value where the RoT is over the corresponding threshold, or by the step-size increase value where the RoT is under the corresponding threshold.

24. The computer program product of claim 22, wherein the one or more control parameters correspond to an in-cell load, and the code for causing the at least one computer to adjust adjusts the scheduled load by the step-size decrease value where the in-cell load is over the corresponding threshold, or by the step-size increase value where the in-cell load is under the corresponding threshold.

25. The computer program product of claim 22, wherein the one or more control parameters correspond to a rise-over-thermal (RoT) and an in-cell load, and the code for causing the at least one computer to adjust adjusts scheduled load by the step-size decrease value where either the RoT or the in-cell load is over the corresponding threshold, or by the step-size increase value where the RoT and the in-cell load are under the corresponding threshold.

26. The computer program product of claim 22, wherein the computer-readable medium further comprises code for causing the at least one computer to obtain the target tail probability from a hardcoding or configuration.

27. The computer program product of claim 22, wherein the computer-readable medium further comprises code for causing the at least one computer to update the step-size increase value or the step-size decrease value based on receiving a modified target tail probability.

28. The computer program product of claim 22, wherein the code for causing the at least one computer to compute computes the step-size increase value by multiplying the step-size decrease value by the target tail probability for the one or more control parameters.

29. An apparatus for adjusting a scheduled load for one or more user equipment (UE) in a wireless network, comprising:
a step-size initializing component for computing a step-size increase value and a step-size decrease value for adjusting a scheduled load based in part on a target tail probability for one or more control parameters;
a control parameter measuring component for determining a comparison of each of the one or more control parameters related to signals received from one or more UEs to a corresponding threshold; and
a scheduler component for adjusting the scheduled load by the step-size increase value or the step-size decrease value based in part on the comparison.

30. The apparatus of claim 29, wherein the one or more control parameters correspond to a rise-over-thermal (RoT), and the scheduler component adjusts the scheduled load by the step-size decrease value where the RoT is over the corresponding threshold, or by the step-size increase value where the RoT is under the corresponding threshold.

31. The apparatus of claim 29, wherein the one or more control parameters correspond to an in-cell load, and the scheduler component adjusts the scheduled load by the step-size decrease value where the in-cell load is over the corresponding threshold, or by the step-size increase value where the in-cell load is under the corresponding threshold.

32. The apparatus of claim 29, wherein the one or more control parameters correspond to a rise-over-thermal (RoT) and an in-cell load, and the scheduler component adjusts scheduled load by the step-size decrease value where either the RoT or the in-cell load is over the corresponding threshold, or by the step-size increase value where the RoT and the in-cell load are under the corresponding threshold.

33. The apparatus of claim 29, wherein the step-size initializing component obtains the target tail probability from a hardcoding or configuration.

34. The apparatus of claim 29, wherein the step-size initializing component updates the step-size increase value or the step-size decrease value based on receiving a modified target tail probability.

35. The apparatus of claim 29, wherein the step-size initializing component computes the step-size increase value by multiplying the step-size decrease value by the target tail probability for the one or more control parameters.
